(19) United States
(12) Patent Application Publication
(10) Pub. No.: US 2023/0244737 A1
(43) Pub. Date: Aug. 3, 2023

(54) RECOMMENDATION SYSTEM

(71) Applicant: NTT DOCOMO, INC., Chiyoda-ku (JP)

(72) Inventors: Ryoki WAKAMOTO, Chiyoda-ku (JP); Shigeki TANAKA, Chiyoda-ku (JP); Yusuke FUKAZAWA, Chiyoda-ku (JP)

(73) Assignee: NTT DOCOMO, INC., Chiyoda-ku (JP)

(21) Appl. No.: 18/002,598

(22) PCT Filed: Jul. 6, 2021
(86) PCT No.: PCT/JP2021/025451

§ 371 Date: Dec. 20, 2022

(30) Foreign Application Priority Data
Jul. 7, 2020 (JP) 2020-117279

(51) Int. Cl. G06F 16/954; H04L 67/50

(52) U.S. Cl. CPC G06F 16/954; H04L 67/535

(57) ABSTRACT

A recommendation system is a system that performs recommendation for a user over a plurality of different types of services and includes: an acquisition unit configured to acquire use history information indicating use histories of a user in a time series in the plurality of different types of services; a feature quantity converting unit configured to convert a continuous use history in which use of another service has not intervened and that is temporally continuous for the same service out of use histories indicated by the use history information acquired by the acquisition unit to a feature quantity with a fixed length using the continuous use history as a unit; and a determination unit configured to determine information to be recommended for the user based on the feature quantity with the fixed length acquired through conversion by the feature quantity converting unit.

### TECHNICAL FIELD

The present invention relates to a recommendation system that performs recommendation for a user over a plurality of different types of services.

### BACKGROUND ART

In the related art, a system that delivers video, music, books, and games via a network and recommends content based on a use history of a user has been proposed (for example, see Patent Literature 1).

### CITATION LIST

### Patent Literature

[Patent Literature 1] Japanese Unexamined Patent Publication No. 2009-64365

### SUMMARY OF INVENTION

### Technical Problem

It is conceivable to recommend contents of a plurality of different types of services for a user together based on a use history of the user over the services, that is, recommend in cross domains. For example, it is conceivable to recommend contents of services for providing animations, music, and books for a user together based on a use history of the user over the services. Content of a service which is not used by a user can be recommended for the user based on a use history of services which are used by the user by performing such recommendation.

However, when content to be recommended is determined without appropriately considering use histories of the services, appropriate recommendation cannot be performed. For example, services for providing animations and music are considered. In general, time of about several tens of minutes is required for watching an animation, and time of about several minutes is required for hearing a piece of music. Accordingly, when a user uses the same time for animations and music, the number of items in the use history of music is generally larger. When recommendation is performed by handling the use histories in the same way, there is concern that recommendation will be performed with a bias toward a service of music with the larger use history. When use histories of services are not appropriately considered in this way, there is concern that recommendation with a bias toward a specific type of service will be performed.

An embodiment of the present invention was invented in consideration of the aforementioned circumstances and an objective thereof is to provide a recommendation system that can perform appropriate recommendation when recommendation for a user over a plurality of different types of services is performed.

### Solution to Problem

In order to achieve the aforementioned objective, a recommendation system according to an aspect of the present invention is a recommendation system that performs recommendation for a user over a plurality of different types of services, the recommendation system including: an acquisition unit configured to acquire use history information indicating use histories of a user in a time series in the plurality of different types of services; a feature quantity converting unit configured to convert a continuous use history in which use of another service has not intervened and that is temporally continuous for the same service out of use histories indicated by the use history information acquired by the acquisition unit to a feature quantity with a fixed length using the continuous use history as a unit; and a determination unit configured to determine information to be recommended for the user based on the feature quantity with the fixed length acquired through conversion by the feature quantity converting unit.

In the recommendation system according to the embodiment of the present invention, information to be recommended for the user is determined based on the feature quantity with the fixed length to which the continuous use history is converted. Accordingly, with the recommendation system according to the embodiment of the present invention, it is possible to perform appropriate recommendation in appropriate consideration of use histories of a plurality of different types of services when recommendation for a user over the services is performed.

### Advantageous Effects of Invention

According to the embodiment of the present invention, it is possible to perform appropriate recommendation in appropriate consideration of use histories of a plurality of different types of services when recommendation for a user over the services is performed.

### BRIEF DESCRIPTION OF DRAWINGS

FIG. 1 is a diagram illustrating a configuration of a recommendation system according to an embodiment of the present invention.

FIG. 2 is a diagram schematically illustrating recommendation according to the embodiment of the present invention.

FIG. 3 is a diagram illustrating information which is used in the recommendation system.

FIG. 4 is a diagram illustrating a conversion model which is used in the recommendation system.

FIG. 5 is a diagram illustrating a recommendation model which is used in the recommendation system.

FIG. 6 is a sequence diagram illustrating a sequence of processes which are performed in the recommendation system according to the embodiment of the present invention.

FIG. 7 is a diagram illustrating a hardware configuration of the recommendation system according to the embodiment of the present invention.

### DESCRIPTION OF EMBODIMENTS

Hereinafter, a recommendation system according to an embodiment of the present invention will be described with reference to the accompanying drawings. In description with reference to the drawings, the same elements will be referred to by the same reference signs and repeated description thereof will be omitted.

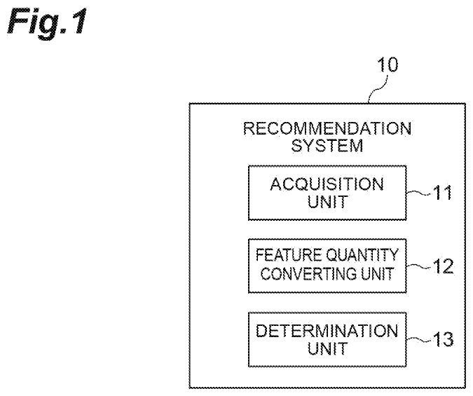

FIG. 1 is a diagram illustrating a configuration of a recommendation system 10 according to an embodiment of the present invention. The recommendation system 10 is a system (device) associated with recommendation for a user over a plurality of different types (domains) of services. For example, a service in which recommendation is to be performed is a service for delivering (providing) content such as animations, music (pieces of music or songs), and books (publications) to a user. In this embodiment, content of three types of services of animations, music, and books will be described as examples.

In this embodiment, content is delivered using different services depending on types of the content. For example, an application (app) for using content is prepared for each type of content. A user installs the application for each service on a terminal which is used by the user and acquires and uses (for example, reproduces or displays) content using the application.

The recommendation system 10 performs recommendation for a user over a plurality of different types of services based on use histories of content of the user. That is, the recommendation system 10 performs recommendation in cross domains. In this embodiment, the recommendation system 10 performs recommendation of content such as animations, music, and books. The recommendation system 10 performs recommendation of a plurality of contents at a time. Content to be recommended by the recommendation system 10 is determined all at once over the plurality of services. For example, when the user accesses a site (for example, a portal site) on which content of a plurality of services (a plurality of applications) is displayed using a terminal of the user, the recommendation system 10 performs recommendation by displaying information indicating content to be recommended on the site. By selecting (for example, clicking) displayed information, the user can use content to be recommended corresponding to the selected information.

The recommendation system 10 is constituted by a computer such as a server device. The recommendation system 10 may be constituted by a plurality of computers, that is, a computer system. The services for delivering content to users can be realized in the same way as in the related art. The recommendation system 10 may be unified with a system (device) that provides the services or may be separate from the system. When the recommendation system 10 and the system that provides the services are separate, the recommendation system 10 and the system that provides the services may each transmit and receive information to and from the other.

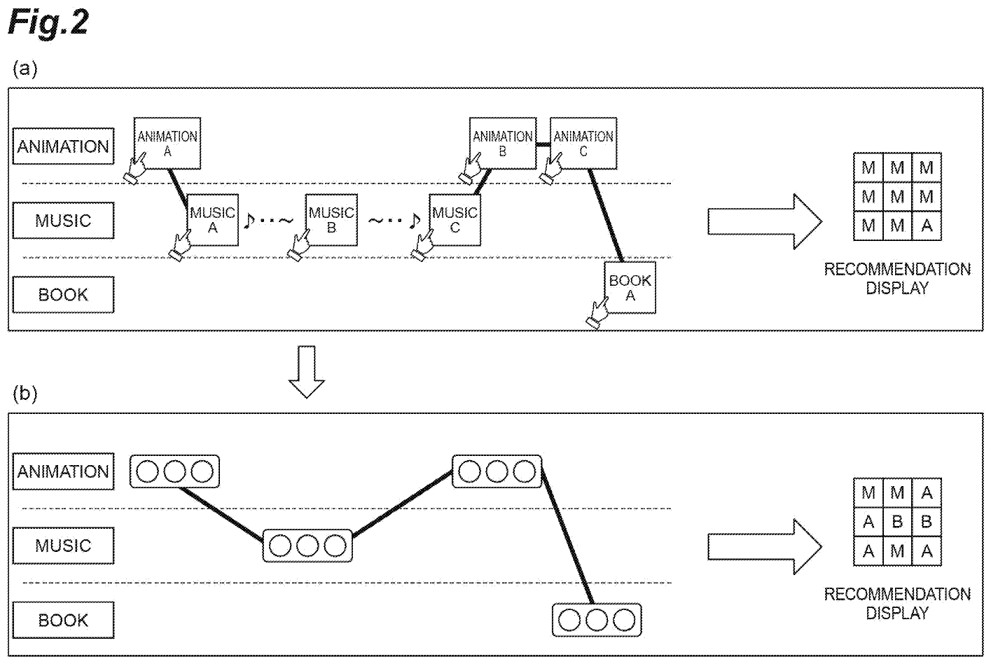

An outline of recommendation according to this embodiment will be described below with reference to FIG. 2. FIG. 2(a) illustrates logs of content used by a user in a time series, that is, use histories of services for the user. In FIG. 2(a), the vertical direction represents a service type (animations, music, and books), and the horizontal direction represents the time (newer toward the right). In this example, the number of logs of animations is three, the number of logs of music is 100, and the number of logs of books is one. When recommendation is performed using a method according to the related art and using data in which the numbers of logs of service types are not the same in this way, recommendation with a bias tends to be performed. For example, there is concern that data of a service type with the larger number of logs will have a stronger influence and recommendation with a bias toward that service type will be performed.

In the example illustrated in FIG. 2(a), for example, when nine items of content are recommended, more content of music with the larger number of logs is recommended. In recommendation illustrated in FIG. 2, “A” indicates that content of animations is recommended, “M” indicates that content of music is recommended, and “B” indicates that content of books is recommended. As described above, a use time for one piece of content differs greatly between animations and music. Accordingly, even when the number of logs of music is larger as in the example illustrated in FIG. 2, a user does not necessarily want recommendation of content of only music.

A sampling method using only partial data is known as a method of arranging the numbers of data pieces (the numbers of logs) over the service types. However, when an important feature is included in data which has not been sampled, there is concern that the important feature will be missed and appropriate recommendation will not be able to be performed.

On the other hand, in this embodiment, as illustrated in FIG. 2(b), a continuous use history in which use of another service has not intervened and that is temporally continuous for the same service out of use histories illustrated in FIG. 2(a) is converted to a feature quantity with a fixed length using the continuous use history as a unit, which is used for recommendation. A feature quantity with a fixed length is a feature quantity including a preset number of pieces of data (for example, numerical values). Conversion to a feature quantity with a fixed length is performed using all use histories which are continuous for the same service. For example, when 100 items of content of music are continuously used without use of content of another service intervening therein as illustrated in FIG. 2(a), the use history of the 100 items of content is converted to one feature quantity with a fixed length.

By performing recommendation using a feature quantity with a fixed length, it is possible to curb an influence of a use history of a service with a large number of logs in consideration of all use histories. That is, according to this embodiment, it is possible to perform appropriate recommendation when recommendation for a user over a plurality of different types of services is performed. As in the example illustrated in FIG. 2(b), it is possible to perform well-balanced recommendation of content of animations, music, and books.

Functions of the recommendation system 10 according to this embodiment will be described below. As illustrated in FIG. 1, the recommendation system 10 includes an acquisition unit 11, a feature quantity converting unit 12, and a determination unit 13.

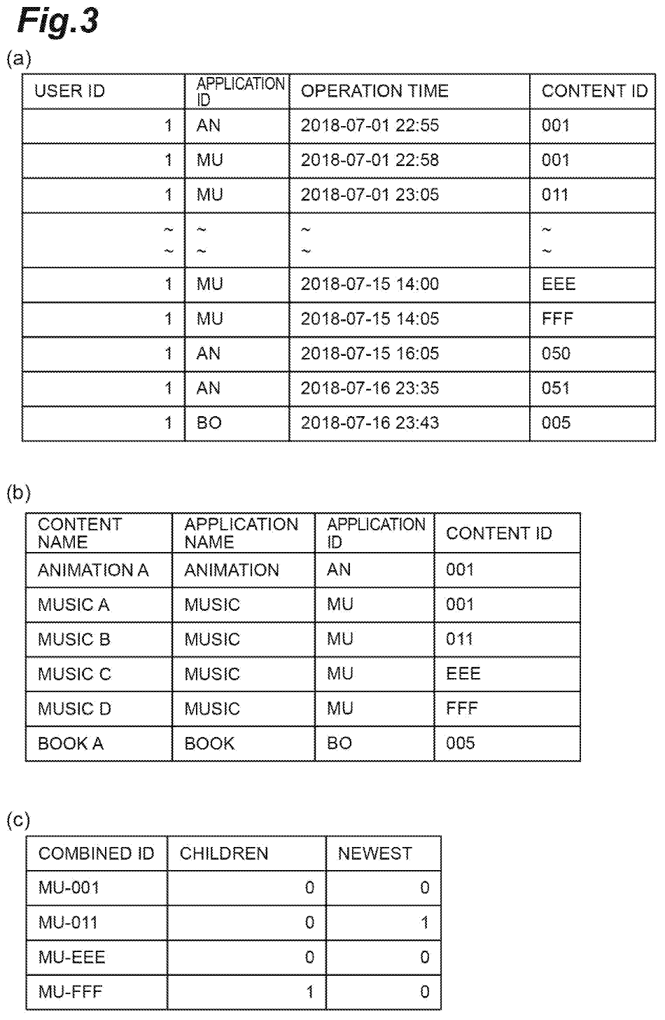

The acquisition unit 11 is a functional unit that acquires use history information indicating use histories for a user in a time series over a plurality of different types of services. For example, the acquisition unit 11 acquires use history information from a system that provides the services. Alternatively, a terminal which is used by a user to use the services may transmit use history information to the recommendation system 10, and the acquisition unit 11 may receive and acquire the use history information transmitted from the terminal. An example of the acquired use history information is illustrated in FIG. 3(a). As illustrated in FIG. 3(a), the use history information is information in which a user ID, an application ID, an operation time, and a content ID are correlated.

A user ID is an ID (information) for identifying a user who uses the corresponding service. When each service is used, user IDs are given to users in advance. An application ID is an ID (information) for identifying an application which is used to use the corresponding service in a terminal. Since applications are provided according to types of services (content) as described above, an application ID also identifies a service type. Application IDs are given to applications in advance. An operation time indicates a time at which a user's operation (for example, clicking) for using content has been performed and is, for example, information of year, date, and time. An operation time can be considered as a time at which a user has used content. A content ID is an ID (information) for identifying content which is used by a user. Content IDs are given to content in advance.

The acquisition unit 11 outputs the acquired use history information to the feature quantity converting unit 12. Alternatively, the acquisition unit 11 may store the acquired use history information in a data server or the like of the recommendation system 10 such that it can be referred to by the feature quantity converting unit 12. Acquisition of the use history information in the acquisition unit 11 can be performed on use history information of a user (use history information of which the user ID is a user ID of the user) when recommendation for the user is performed.

The use history information is not limited to the aforementioned description and may be any information as long as it is information indicating use histories of a user in a time series over a plurality of different types of services. Acquisition of the use history information does not have to be performed as described above and can be performed using an arbitrary method as long as use history information can be acquired.

The recommendation system 10 stores content ID management information as master data in a data server or the like in advance. An example of content ID management information is illustrated in FIG. 3(b). As illustrated in FIG. 3(b), the content ID management information is information in which a content name, an application name, an application ID, and a content ID are correlated. The content name is a content name of a content with the correlated content ID. The application name is an application name of an application with the correlated application ID (an application for using content with the correlated content ID). The content name and the application name can be ascertained based on the content ID and the application ID with reference to the content ID management information.

Meta information is set in advance in each piece of contents. The meta information of content represents features of the content and is, for example, information indicating whether the corresponding content is for children or whether the corresponding content is the newest. The recommendation system 10 stores contents meta management information as master data for managing meta information in the data server or the like in advance. An example of the content meta management information is illustrated in FIG. 3(c). As illustrated in FIG. 3(c), the content meta management information is information in which a combined ID, information for children, and newest information are correlated. The combination ID is an ID in which an application ID and a content ID are connected with “- (hyphen).”

The information for children is information indicating whether the content indicated by the combined ID is content for children. The information for children indicates that the corresponding content is content for children when it is 1, and the information for children indicates that the corresponding content is not content for children when it is 0. The newest information is information indicating whether the content indicated by the combined ID is the newest content. The newest information indicates that the corresponding content is the newest when it is 1, and the newest information indicates that the corresponding content is not the newest when it is 0. The information for children and the newest information are set for each piece of content in advance. The information for children and the newest information which are meta information can be acquired based on the content ID and the application ID with reference to the content meta management information. Arbitrary information other than described above may be used as meta information of content.

The feature quantity converting unit 12 is a functional unit that converts a continuous use history in which use of another service has not intervened and that is temporally continuous for the same service out of use histories indicated by the use history information acquired by the acquisition unit 11 to a feature quantity with a fixed length with the continuous use history as a unit. The feature quantity converting unit 12 may convert the continuous use history to a feature quantity with a fixed length by inputting the continuous use history to a conversion model which is generated by machine learning in a unit of use (a unit of used contents) and in the order of a time series. The feature quantity converting unit 12 may convert use histories to a feature quantity with a fixed length using a conversion model including a recurrent neural network (RNN). The feature quantity converting unit 12 performs conversion of the use history information to the feature quantity with a fixed length in a unit of users using the use history information for each user. Specifically, the feature quantity converting unit 12 performs conversion to the feature quantity with a fixed length as follows.

The feature quantity converting unit 12 receives use history information from the acquisition unit 11. The feature quantity converting unit 12 arranges the use history information in the order of operation times and sets continuous use history information for the same application ID as use history information which is converted to one feature quantity with a fixed length. In the following processes, use histories included in the continuous use history indicated by the use history information which is converted to one feature quantity with a fixed length are processed in the order of operation times. The feature quantity converting unit 12 acquires meta information of content indicated by the use histories from the content meta management information.

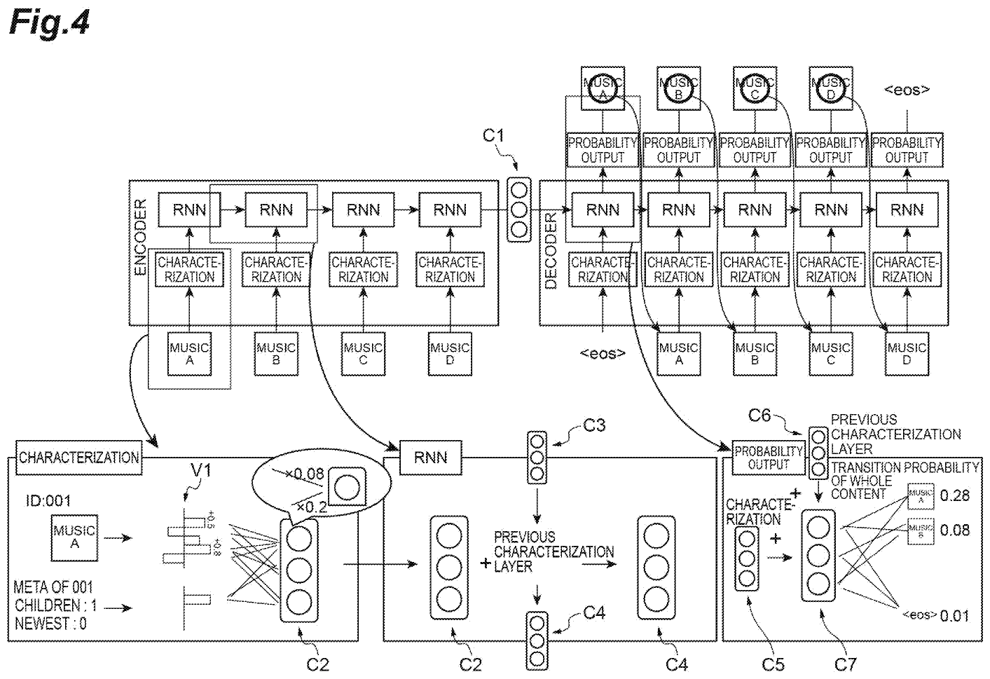

The feature quantity converting unit 12 stores the conversion model in advance and performs conversion of the continuous use history to a feature quantity with a fixed length using the conversion model. The conversion model (algorithm) is schematically illustrated in FIG. 4. The conversion model is a model for inputting information of content indicated by the use history information and acquiring a fixed-length feature quantity C1. The conversion model is common to a plurality of services. The conversion model includes, for example, a neural network generated by machine learning. The neural network may be a multi-layer network, that is, is a network generated by performing deep learning.

The conversion model is constructed by using a sequence-to-sequence (seq2seq) model which is a translation model for language translation. The conversion model includes an encoder and a decoder. Each of the encoder and the decoder includes an RNN. The encoder receives an input of a continuous use history in the units of used content and in the order of a time series and outputs the fixed-length feature quantity C1. The fixed-length feature quantity C is a vector with a preset number of dimensions.

The continuous use history can be regarded as one sentence to be translated in language translation. Information in a unit of content input to the encoder corresponds to information of words input to the encoder once in language translation. In the example illustrated in FIG. 4, the continuous use histories are referred to as “music A,” “music B,” “music C,” and “music D.” When a sentence “Wagahai ha neko de am (I am a cat)” in Japanese is translated using a translation model, inputting to the encoder is performed in the units of “Wagahai,” “ha,” “neko,” “de,” and “aru.” In this case, “music A,” “music B,” “music C,” and “music D” correspond to “Wagahai,” “ha,” “neko,” “de,” and “aru.”

The decoder receives an input of a fixed-length feature quantity C1 and outputs an input of information corresponding to the output and the aforementioned use histories. Information output from the decoder corresponds to a translated sentence in language translation. In the example illustrated in FIG. 4, the decoder sequentially outputs information corresponding to “music A,” “music B,” “music C,” “music D,” and “<eos>.” Here, “<eos>” (End of String) is information indicating an end of a series of information. When a sentence “Wagahai ha neko de am (I am a cat)” in Japanese is translated using a translation model, a sentence “I am a cat” in English is output, and the decoder sequentially outputs information corresponding to “I,” “am,” “a,” “cat,” and “<eos>.” In this case, “music A,” “music B,” “music C,” and “music D” correspond to “I,” “am,” “a,” and “cat.” An output of a translation model is information corresponding to a translated sentence, but an output of a conversion model in this embodiment is the same as an input of the model, and the two models are different in this regard. Since the output of the conversion model in this embodiment is a prediction, it does not necessarily correspond to the same as the input of the conversion model.

The feature quantity converting unit 12 inputs the ID and the meta information of content indicated by the use history information to the encoder of the conversion model. The input ID of content is a content ID or a combined ID. The input meta information is a value of 1 or 0 with the number of dimensions of meta information (two dimensions of information for children and newest information in this embodiment).

The feature quantity converting unit 12 may characterize information input to the conversion model in calculation using the conversion model. Characterization can be performed in the encoder of the conversion model in the same way as in the related art. First, the feature quantity converting unit 12 converts an ID of content input to the encoder of the conversion model to a N-dimensional vector V1 (where N is set in advance) correlated with the ID in advance. Subsequently, the feature quantity converting unit 12 converts the N-dimensional vector V1 and the input meta information to a feature quantity C2 which is a preset number of numerical values (that is, a vector with a preset number of dimensions). The numerical values of the feature quantity C2 correspond to numerical values of neurons in a neural network. Conversion of the vector V1 and the meta information to the feature quantity C2 is performed based on a numerical value (a weight) set for connection between numerical values in the same way as normal calculation in the neural network. The vector V1 correlated with the ID of content and the weight for converting the vector V1 and the meta information to the feature quantity C2 are generated by machine learning. The vector V1 at a time point at which machine learning starts includes random numerical values.

The feature quantity converting unit 12 inputs the feature quantity C2 to the RNN included in the encoder of the conversion model. The feature quantity converting unit 12 inputs a feature quantity C3 (a previous characterization layer) acquired through calculation on an immediately preceding use history out of the continuous use histories and processed in the RNN to the RNN. The feature quantity converting unit 12 generates a feature quantity C4 by adding the feature quantities C2 and C3. The feature quantity C4 generated at this time is input as the feature quantity C3 to the RNN at the time of calculation of a subsequent use history out of the continuous use histories. When the use history input to the RNN is a first use history out of the continuous use histories, a feature quantity set and stored in advance (for example, a feature quantity in which the values of all elements are 0) is used as the feature quantity C3 because calculation on an immediately preceding use history is not performed. By using the RNN in this way, it is possible to output the fixed-length feature quantity C1 in consideration all of the continuous use histories including the order.

The feature quantity converting unit 12 sets the feature quantity C4 acquired through calculation of a final use history out of the continuous use histories and processed in the RNN as the fixed-length feature quantity C1. The feature quantity converting unit 12 converts each continuous use history to a fixed-length feature quantity C1 as described above. Accordingly, the fixed-length feature quantities C1 corresponding to the number of continuous use histories are generated. The feature quantity converting unit 12 outputs the converted fixed-length feature quantities C1 to the determination unit 13.

The decoder of the conversion model is not used for recommendation in the recommendation system 10. Accordingly, a decoder may not be stored in the recommendation system 10. The decoder also needs to be generated when the encoder is generated by machine learning. A function of the decoder will be described below.

An ID and meta information of content are input to the decoder. The content is content identified through calculation on an ID and meta information of an immediately preceding content in the decoder. The ID and meta information of content input to the decoder are characterized in the same way as characterization in the encoder and are converted to a feature quantity C5. The feature quantity C5 is input to the RNN of the decoder. A feature quantity C6 (a previous characterization layer) acquired through calculation on an ID and meta information of an immediately preceding content and processed in the RNN is input to the RNN. In the RNN, a feature quantity C7 is generated by adding the feature quantities C5 and C6. The feature quantity C7 generated at this time is input as the feature quantity C6 to the RNN at the time of calculation on an ID and meta information of subsequent contents.

An ID and meta information of content which are first input to the decoder are information associated with “<eos>.” The ID and meta information associated with “<eos>” are set in advance. The feature quantity input to the decoder is the fixed-length feature quantity C1. To the RNN, the fixed-length feature quantity C1 is first input as the feature quantity C6, and the feature quantity C5 associated with “<eos>” is input.

Information output from the decoder in response to an ID and meta information of the input contents is, for example, numerical values (a vector with dimensions corresponding to the number of items of content of all services) indicating a degree (a transition probability) of content to be output. As illustrated in FIG. 4, “<eos>” is included in the content associated with the output. For example, as illustrated in FIG. 4, the numerical values are numerical values in a range of 0 to 1, and a larger numerical value indicates a higher degree of content to be output. The ID and meta information of content with a largest numerical value to be output are input to the decoder in the next time. In the decoder, information of the output is calculated based on the feature quantity C7 generated by the RNN. This calculation is performed based on a numerical value (a weight) set for connection between numerical values similarly to normal calculation in the neural network. The weight is generated by machine learning.

Generation of the conversion model through machine learning can be performed, for example, using use history information for machine learning (which is different from that used for recommendation) as learning data (training data). In this case, in information of the output from the decoder, the numerical value of the corresponding content is set to 1 and the numerical values of the other content are set to 0. Learning data may be data of a user who is a recommendation target, may be data of a user who is other than a recommendation target, or may be data in which they are mixed. Generation of the conversion model may be performed by the recommendation system 10 or may be performed by a system (device) other than the recommendation system 10.

The conversion model used in the recommendation system 10 is assumed to be used as a program module which is a part of artificial intelligence software. The conversion model is used in a computer including a CPU and a memory. Specifically, the CPU of the computer operates to perform calculation based on a weighting factor or the like trained in a neural network by inputting information to an input layer of the neural network in accordance with a command from the conversion model stored in the memory and to output a result from an output layer of the neural network.

The determination unit 13 is a functional unit that determines information to be recommended for a user based on a feature quantity with a fixed length acquired through conversion by the feature quantity converting unit 12. The determination unit 13 may determine information to be recommended for a user by inputting the feature quantity with a fixed length acquired through conversion by the feature quantity converting unit 12 to a recommendation model which is generated by machine learning in a unit of a feature quantity with a fixed length and in the order of a time series. The determination unit 13 may determine information to be recommended for a user using a recommendation model including an RNN. The determination unit 13 determines content to be recommended for each user using the fixed-length feature quantity C1 for each user. Specifically, the determination unit 13 determines content to be recommended as follows.

The determination unit 13 receives an input of the fixed-length feature quantities C1 of a user who is a recommendation target from the feature quantity converting unit 12. The determination unit 13 arranges the fixed-length feature quantities C1 in the order of operation times. In the following routine, the fixed-length feature quantities C1 are processed in the order of operation times.

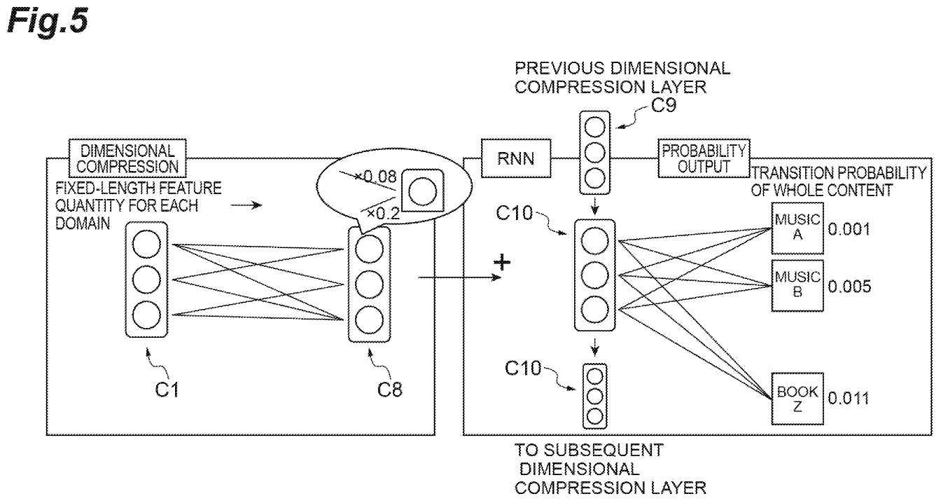

The determination unit 13 stores a recommendation model in advance and determines content to be recommended using the recommendation model. A recommendation model (algorithm) is schematically illustrated in FIG. 5. The recommendation model is a model for inputting a fixed-length feature quantity C1 and outputting information of content to be recommended for a user (subsequent contents). The recommendation model includes, for example, a neural network generated by machine learning. The neural network may be a multi-layer network, that is, a neural network which is generated by performing deep learning.

Information of content to be recommended which are output from the recommendation model is, for example, numerical values (a vector with dimensions corresponding to the number of items of content of all services) indicating a degree of recommendation (a transition probability) of the contents. The recommendation model is common to a plurality of services. For example, as illustrated in FIG. 5, the numerical values are numerical values in a range of 0 to 1, and a larger numerical value indicates a higher degree of recommendation. These numerical values can be regarded as probabilities at which a user uses the corresponding contents.

The determination unit 13 inputs fixed-length feature quantities C1 to the recommendation model in the order of a time series and acquires an output from the recommendation model by performing calculation using the recommendation model.

The determination unit 13 may perform dimensional compression of the fixed-length feature quantities C1 input to the recommendation model. The dimensional compression is performed in the recommendation model and can be performed in the same way as in the related art (in the same way as conversion of the vector V1 and meta information to the feature quantity C2). The determination unit 13 converts a fixed-length feature quantity C1 to a feature quantity C8 which is a preset number of numerical values (that is, a vector with dimensions corresponding to a preset number). The number of dimensions of the feature quantity C8 is smaller than the number of dimensions of the fixed-length feature quantity C1. The numerical values of the feature quantity C8 correspond to numerical values of neurons in the neural network. Conversion of the fixed-length feature quantity C1 to the feature quantity C8 is performed based on a numerical value (a weight) set for connection between numerical values in the same way as normal calculation in the neural network. The weight for converting the fixed-length feature quantity C1 to the feature quantity C8 is generated by machine learning. The dimensional compression may not be necessarily performed, and the fixed-length feature quantity C1 may be used in subsequent processes.

The determination unit 13 inputs the feature quantity C8 subjected to the dimensional compression to the RNN included in the recommendation model. The determination unit 13 inputs a feature quantity C9 (a previous dimensional compression layer) acquired through calculation on the previous feature quantity C8 and processed in the RNN to the RNN. The determination unit 13 generates a feature quantity C10 by adding the feature quantities C8 and C9. The feature quantity C10 generated at this time is input as the feature quantity C9 to the RNN at the time of calculation of a subsequent fixed-length feature quantity C1. When the fixed-length feature quantity C1 is a first fixed-length feature quantity C1, a feature quantity set and stored in advance (for example, a feature quantity in which the values of all elements are 0) is used as the feature quantity C9 because calculation on an immediately preceding fixed-length feature quantity C1 is not performed. By using the RNN in this way, it is possible to output information of content to be recommended in consideration of the fixed-length feature quantities C1 hitherto, that is, in consideration of all of use histories of a user hitherto including the order.

The determination unit 13 calculates information of content to be recommended from the feature quantity C10 acquired by inputting the final fixed-length feature quantity C1 acquired from use history information of a user to the recommendation model. This calculation is performed based on a numerical value (a weight) set for connection between numerical values similarly to normal calculation in the neural network. The weight is generated by machine learning.

Generation of the recommendation model through machine learning can be performed, for example, using use history information for machine learning (which is different from that used for recommendation) as learning data (training data). In this case, information of content to be recommended corresponding to the output may be set as follows. For example, all use history information is not used as an input, the numerical value of content which has been actually used subsequently to the use history information corresponding to the input is set to 1, and the numerical values of the other content are set to 0. Generation of the recommendation model may be performed by the recommendation system 10 or may be performed by a system (device) other than the recommendation system 10.

The recommendation model used in the recommendation system 10 is assumed to be used as a program module which is a part of artificial intelligence software. The recommendation model is used in a computer including a CPU and a memory. Specifically, the CPU of the computer operates to perform calculation based on a weighting factor or the like trained in a neural network by inputting information to an input layer of the neural network in accordance with a command from the recommendation model stored in the memory and to output a result from an output layer of the neural network.

The determination unit 13 determines content to be recommended for a user based on the calculated information of content to be recommended. For example, the determination unit 13 determines content in which the numerical values of the content indicated by the information of subsequent content are ranked to N from the top rank as content to be recommended for a user. Here, N is a numerical value set and stored in advance. The determination unit 13 outputs information of the determined contents. For example, the determination unit 13 transmits the information of the determined content to a terminal of a user as described above such that the information is displayed. At this time, a content name and an application name may be acquired as the information of content to be displayed on the terminal of the user from the content ID management information illustrated in FIG. 3(b). Determination of the content to be recommended for a user does not have to be performed as described above and has only to be performed based on the calculation results. Output of information may also be performed a method other than described above. Up to now, the functions of the recommendation system 10 according to this embodiment have been described.

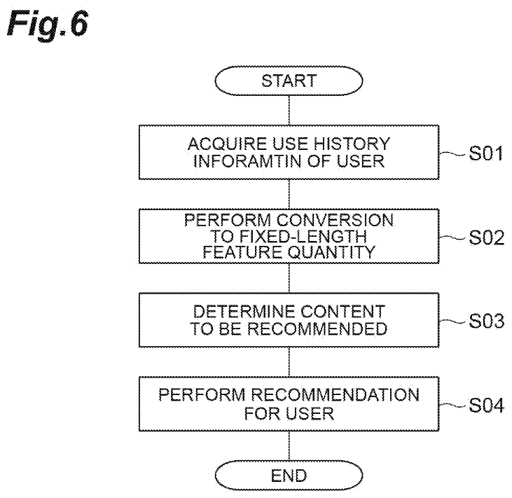

A routine of processes which are performed by the recommendation system 10 according to this embodiment (an operation method which is performed by the recommendation system 10) will be described below with reference to the flowchart illustrated in FIG. 6. This routine is performed for each user when recommendation of content for a user is performed. In this routine, the acquisition unit 11 acquires use history information of a user (S01). Subsequently, the feature quantity converting unit 12 converts a continuous use history out of use histories indicated by the use history information to a fixed-length feature quantity (S02). This conversion is performed using the aforementioned conversion model. Subsequently, the determination unit 13 determines content to be recommended for the user from the fixed-length feature quantity (S03). This determination is performed using the aforementioned recommendation model.

Subsequently, the determination unit 13 performs recommendation of the determined content (S04). Up to now, the routine of processes performed by the recommendation system 10 according to this embodiment has been described.

In this embodiment, information to be recommended for a user is determined based on the feature quantities with a fixed length to which the continuous use history is converted. Accordingly, according to this embodiment, it is possible to perform appropriate recommendation in consideration of use histories of a plurality of different types of services when recommendation for a user over the services is performed. Specifically, a short continuous use history and a long continuous use history in the services can be converted to feature quantities with a fixed length to be handled. Through this handling, for example, even when 100 use histories of music are continuous as illustrated in FIG. 2, it is possible to prevent recommendation with a bias toward music. Alternatively, even when the numbers of use histories of animation and book are small, it is possible to prevent content of such services from not being recommended. As a result, it is possible to perform recommendation of various types of content for a user whose use is biased toward some services.

As in this embodiment, a continuous use history may be converted to a feature quantity with a fixed length by inputting the continuous use history to the conversion model in the units of use and in the order of a time series. The conversion model may include an RNN. With this configuration, it is possible to reliably and appropriately perform conversion to a feature quantity with a fixed length and thus to perform appropriate recommendation. For example, by using a conversion model with a translation model as a base as described above, it is possible to perform conversion to a feature quantity with a fixed length in appropriate consideration of information in a time series. Here, conversion to a feature quantity with a fixed length does not have to be performed as described above as long as conversion can be performed with the continuous use history as a unit.

As in this embodiment, information to be recommended for a user may be determined by inputting a feature quantity with a fixed length to a recommendation model in units of a feature quantity with a fixed length and in the order of a time series. The recommendation model may include an RNN. With this configuration, it is possible to perform reliable and appropriate recommendation. Here, determination of information to be recommended for a user does not have to be performed as described above as long as the determination is performed based on a feature quantity with a fixed length.

In the aforementioned embodiment, recommendation of content which are provided such as animation, music, and book has been exemplified above, but recommendation of other content may be performed. A recommendation object in the recommendation system 10 is not limited to the aforementioned content as long as content is sequentially used by a user. Use in this case may be based on a mode (for example, ordering) corresponding to the recommendation target.

In the block diagrams with reference to which the embodiment has been described, blocks of functional units are illustrated. These functional blocks (constituents) are realized by an arbitrary combination of at least one of hardware and software. The realization method of the functional blocks is not particularly limited. That is, the functional blocks may be realized by a single device which is physically or logically coupled, or may be realized by two or more devices which are physically or logically separated and which are directly or indirectly connected (for example, in a wired or wireless manner). The functional blocks may be realized by combining software with the single device or the two or more devices.

The functions include determining, deciding, determination, calculating, computing, processing, deriving, investigating, searching, ascertaining, receiving, transmitting, outputting, accessing, resolving, selecting, choosing, establishing, comparing, supposing, expecting, considering, broadcasting, notifying, communicating, forwarding, configuring, reconfiguring, allocating or mapping, and assigning, but are not limited thereto. For example, a functional block (constituent) for transmitting is referred to as a transmitting unit or a transmitter. As described above, the realizing method of each functional block is not particularly limited.

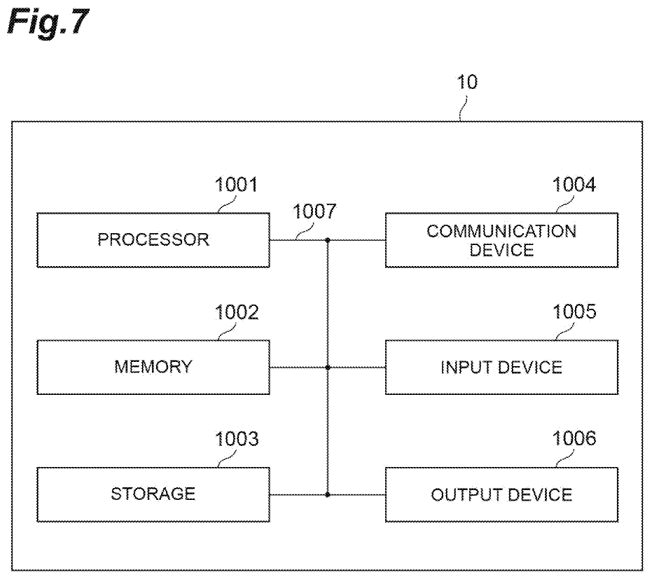

For example, the recommendation system 10 according to the embodiment of the present disclosure may serve as a computer that performs information processing according to the present disclosure. FIG. 7 is a diagram illustrating an example of a hardware configuration of the recommendation system 10 according to the embodiment of the present disclosure. The recommendation system 10 may be physically configured as a computer device including a processor 1001, a memory 1002, a storage 1003, a communication device 1004, an input device 1005, an output device 1006, and a bus 1007.

In the following description, the term “device” can be replaced with circuit, device, unit, or the like. The hardware configuration of the recommendation system 10 may include one or more devices illustrated in FIG. 4 or may not include some devices thereof.

The functions of the recommendation system 10 can be realized by reading predetermined software (programs) to hardware such as the processor 1001 and the memory 1002 and causing the processor 1001 to execute arithmetic operations and to control communication using the communication device 1004 or to control reading and/or writing of data with respect to the memory 1002 and the storage 1003.

The processor 1001 controls a computer as a whole, for example, by causing an operating system to operate. The processor 1001 may be configured as a central processing unit (CPU) including an interface with peripherals, a controller, an arithmetic operation unit, and a register. For example, the functions of the recommendation system 10 may be realized by the processor 1001.

The processor 1001 reads a program (a program code), a software module, data, or the like from the storage 1003 and/or the communication device 1004 to the memory 1002 and performs various processes in accordance therewith. As the program, a program that causes a computer to perform at least some of the operations described above in the embodiment is used. For example, the functions of the recommendation system 10 may be realized by a control program which is stored in the memory 1002 and which operates in the processor 1001. The various processes described above are described as being performed by a single processor 1001, but they may be simultaneously or sequentially performed by two or more processors 1001. The processor 1001 may be mounted as one or more chips. The program may be transmitted from a network via an electrical communication line.

The memory 1002 is a computer-readable recording medium and may be constituted by, for example, at least one of a read only memory (ROM), an erasable programmable ROM (EPROM), an electrically erasable programmable ROM (EEPROM), and a random access memory (RAM). The memory 1002 may be referred to as a register, a cache, a main memory (a main storage device), or the like. The memory 1002 can store a program (a program code), a software module, and the like that can be executed to perform information processing according to an embodiment of the present disclosure.

The storage 1003 is a computer-readable recording medium and may be constituted by, for example, at least one of an optical disc such as a compact disc ROM (CD-ROM), a hard disk drive, a flexible disk, a magneto-optical disc (for example, a compact disc, a digital versatile disc, or a Blu-ray (registered trademark) disc), a smart card, a flash memory (for example, a card, a stick, or a key drive), a floppy (registered trademark) disk, and a magnetic strip. The storage 1003 may be referred to as an auxiliary storage device. The storage media of the recommendation system 10 may be, for example, a database, a server, or another appropriate medium including the memory 1002 and/or the storage 1003.

The communication device 1004 is hardware (a transmitting and receiving device) that performs communication between computers via a wired and/or wireless network and is also referred to as, for example, a network device, a network controller, a network card, or a communication module.

The input device 1005 is an input device that receives an input from the outside (for example, a keyboard, a mouse, a microphone, a switch, a button, or a sensor). The output device 1006 is an output device that performs an output to the outside (for example, a display, a speaker, or an LED lamp). The input device 1005 and the output device 1006 may be configured as a unified body (for example, a touch panel).

The devices such as the processor 1001 and the memory 1002 are connected to each other via the bus 1007 for transmission of information. The bus 1007 may be constituted by a single bus or may be constituted by buses which are different depending on the devices.

The recommendation system 10 may be configured to include hardware such as a microprocessor, a digital signal processor (DSP), an application-specific integrated circuit (ASIC), a programmable logic device (PLD), or a field-programmable gate array (FPGA), and some or all of the functional blocks may be realized by the hardware. For example, the processor 1001 may be mounted as at least one piece of such hardware.

The order of processes, the sequences, the flowcharts, and the like of the aspects/embodiments described above in the present disclosure may be changed unless conflictions arise. For example, in the methods described in the present disclosure, various steps are described as elements of an exemplary order, but the methods are not limited to the described order.

Information or the like which is input or output may be stored in a specific place (for example, a memory) or may be managed using a management table. Information or the like which is input or output may be overwritten, updated, or added. Information or the like which is output may be deleted. Information or the like which is input may be transmitted to another device.

Determination may be performed using a value (0 or 1) which is expressed in one bit, may be performed using a Boolean value (true or false), or may be performed by comparison of numerical values (for example, comparison with a predetermined value).

The aspects/embodiments described in this specification may be used alone, may be used in combination, or may be switched during implementation thereof. Notifying of predetermined information (for example, notifying that “it is X”) is not limited to explicit notification, and may be performed by implicit notification (for example, notifying of the predetermined information is not performed).

While the present disclosure has been described above in detail, it will be apparent to those skilled in the art that the present disclosure is not limited to the embodiments described in the present disclosure. The present disclosure can be altered and modified in various forms without departing from the gist and scope of the present disclosure defined by description in the appended claims. Accordingly, the description in the present disclosure is for exemplary explanation and does not have any restrictive meaning for the present disclosure.

Regardless of whether it is called software, firmware, middleware, microcode, hardware description language, or another name, software can be widely construed to refer to a command, a command set, a code, a code segment, a program code, a program, a sub program, a software module, an application, a software application, a software package, a routine, a sub routine, an object, an executable file, an execution thread, a sequence, a function, or the like.

Software, a command, information, and the like may be transmitted and received via a transmission medium. For example, when software is transmitted from a web site, a server, or another remote source using at least one of wired technology (such as a coaxial cable, an optical fiber cable, a twisted-pair wire, or a digital subscriber line (DSL)) and wireless technology (such as infrared rays or microwaves), the at least one of wired technology and wireless technology is included in the definition of the transmission medium.

The terms “system” and “network” used in the present disclosure are compatibly used.

Information, parameters, and the like described above in this specification may be expressed as absolute values, may be expressed as values relative to predetermined values, or may be expressed using other corresponding information.

The term “determining” or “determination” used in the present disclosure may include various types of operations. The term “determining” or “determination” may include cases in which judging, calculating, computing, processing, deriving, investigating, looking up, search, or inquiry (for example, looking up in a table, a database, or another data structure), and ascertaining are considered to be “determined.” The term “determining” or “determination” may include cases in which receiving (for example, receiving information), transmitting (for example, transmitting information), input, output, and accessing (for example, accessing data in a memory) are considered to be “determined.” The term “determining” or “determination” may include cases in which resolving, selecting, choosing, establishing, comparing, and the like are considered to be “determined.” That is, the term “determining” or “determination” can include cases in which a certain operation is considered to be “determined.” “Determining” may be replaced with “assuming,” “expecting,” “considering,” or the like.

The terms “connected” and “coupled” or all modifications thereof refer to all direct or indirect connecting or coupling between two or more elements, and can include a case in which one or more intermediate elements are present between the two elements “connected” or “coupled” to each other. Coupling or connecting between elements may be physical, logical, or a combination thereof. For example, “connecting” may be replaced with “access.” In the present disclosure, two elements can be considered to be “connected” or “coupled” to each other using at least one of one or more electrical wires, cables, and printed circuits and using electromagnetic energy or the like having wavelengths of a radio frequency area, a microwave area, and a light (both visible and invisible light) area in some non-limiting and non-inclusive examples.

The expression “based on” used in the present disclosure does not mean “based on only” unless otherwise described. In other words, the expression “based on” means both “based on only” and “based on at least.”

No reference to elements named with “first,” “second,” or the like used in the present disclosure generally limit amounts or order of the elements. These naming can be used in the present disclosure as a convenient method for distinguishing two or more elements.

Accordingly, reference to first and second elements does not mean that only two elements are employed or that a first element precedes a second element in any form.

When the terms “include” and “including” and modifications thereof are used in the present disclosure, the terms are intended to have a comprehensive meaning similar to the term “comprising.” The term “or” used in the present disclosure is not intended to mean an exclusive logical sum.

In the present disclosure, for example, when an article such as a, an, or the in English is added in translation, the present disclosure may include a case in which a noun subsequent to the article is of a plural type.

In the present disclosure, the expression “A and B are different” may mean that “A and B are different from each other.” The expression may mean that “A and B are different from C.” Expressions such as “separated” and “coupled” may be construed in the same way as “different.”

### REFERENCE SIGNS LIST

10 . . . Recommendation system
11 . . . Acquisition unit
12 . . . Feature quantity converting unit
13 . . . Determination unit
1001 . . . Processor
1002 . . . Memory
1003 . . . Storage
1004 . . . Communication device
1005 . . . Input device
1006 . . . Output device
1007 . . . Bus

1. A recommendation system that performs recommendation for a user over a plurality of different types of services, the recommendation system comprising circuitry configured to:
acquire use history information indicating use histories of a user in a time series in the plurality of different types of services;
convert a continuous use history in which use of another service has not intervened and that is temporally continuous for the same service out of use histories indicated by the use history information to a feature quantity with a fixed length using the continuous use history as a unit; and
determine information to be recommended for the user based on the feature quantity with the fixed length.

2. The recommendation system according to claim 1, wherein the circuitry converts the continuous use history to the feature quantity with the fixed length by inputting the continuous use history to a conversion model generated by machine learning in a unit of use and in the order of a time series.

3. The recommendation system according to claim 2, wherein the circuitry converts the continuous use history to the feature quantity with the fixed length using a conversion model including an RNN.

4. The recommendation system according to claim 1, wherein the circuitry determines information to be recommended for the user by inputting the feature quantity with the fixed length to a recommendation model generated by machine learning in a unit of a feature quantity with the fixed length and in the order of a time series.

5. The recommendation system according to claim 4, wherein the circuitry determines information to be recommended for the user using a recommendation model including an RNN.

6. The recommendation system according to claim 2, wherein the circuitry determines information to be recommended for the user by inputting the feature quantity with the fixed length to a recommendation model generated by machine learning in a unit of a feature quantity with the fixed length and in the order of a time series.

7. The recommendation system according to claim 3, wherein the circuitry determines information to be recommended for the user by inputting the feature quantity with the fixed length to a recommendation model generated by machine learning in a unit of a feature quantity with the fixed length and in the order of a time series.
